(19) United States
(12) Patent Application Publication
(10) Pub. No.: US 2023/0169644 A1
(43) Pub. Date: Jun. 1, 2023

(54) COMPUTER VISION SYSTEM AND METHOD FOR ASSESSING ORTHOPEDIC SPINE CONDITION

(71) Applicant: PONG YUEN HOLDINGS LIMITED, Hong Kong (HK)

(72) Inventor: Shun Yin CHAU, Hong Kong (HK)

(21) Appl. No.: 17/537,623

(22) Filed: Nov. 30, 2021

(51) Int. Cl. G06T 7/00; G06T 7/13; G06T 7/73

(52) U.S. Cl. CPC G06T 7/0012; G06T 7/13; G06T 7/75; G06T 2207/10121; G06T 2207/10088; G06T 2207/20081; G06T 2207/30012; G06T 2210/12; G06T 2207/20061

(57) ABSTRACT

A computer vision system and method for an orthopedic assessment of the human spine condition. The system uses frontal and sagittal images of the human spine to detect the vertebrae of the spine. More specifically, four edges of each and every vertebra are detected, and the corresponding straight lines, which can be used for assessment, diagnosis and evaluation of various spinal disorders and diseases by orthopedic doctors, are exported. The system has two phases. In phase one, deep learning algorithm for object detection is applied to detect and localize each and every vertebra of frontal and sagittal images of the human spine. In phase two, the system extracts straight lines that correspond to each of the four edges. Using the straight lines, metrics for the spinal assessment, such as the curvature of the spine, the distance of consecutive vertebrae, and crucial angles such as the Cobb angle, can be determined.

### FIELD OF THE DISCLOSURE

The present disclosure relates in general to the medical science field of orthopedics, and the computer science field of object detection in computer vision through deep learning (i.e., artificial intelligence and machine learning), using the architecture of an edge computing platform. More specifically, the present disclosure relates to a system and method that processes frontal and sagittal images of the human spine, and aims at assisting orthopedic doctors in the diagnosis and assessment of various spinal disorders and diseases.

### BACKGROUND OF THE DISCLOSURE

To begin with, the state of art that clinics and hospitals follow for diagnosis, evaluation and treatment of spinal disorders and diseases is described.

Orthopedic doctors in clinics and hospitals offer state-of-the-art evaluation and treatment of disorders of the Cervical spine (i.e. the upper seven vertebrae, C1-C7 of the human spine), Thoracic spine (i.e. the next lower twelve vertebrae, T1-T12 of the human spine) Lumbar spine (i.e. the next lower five vertebrae, L1-L5, of the human spine), Sacrum (i.e. the next lower five vertebrae, S1-S5, of the human spine) and Coccyx (i.e. the lowest part, the base, the terminal segment of the human spine) specializing in initial evaluations, diagnosis and treatment of entire range of spinal conditions including:

Disc diseases, and Disc Prolapse, Spondylitis, Degenerative Disc disease, Spondylosis, Spondylolisthesis, Oblique Lumbar Interbody Fusion (OLIF), Spinal Stenosis, (including Cervical and Lumbar), Scoliosis, Kyphosis, Lordosis, Compression Fractures and Cervical Fractures of the spine, Spinal tumors, Myelopathy, Radiculopathy, Infections, Spinal Disc Replacement Surgery, Minimally Invasive Spine Surgery (MISS).

In general, orthopedic doctors need assistance in the assessment of a wide range of spinal disorders including: Scoliosis with its sub-categories (Thoracic, Lumbar, and their combinations), Compression Fractures, Kyphosis, Degenerative Discs.

According to the procedural state-of-art, evaluation and treatment of spinal disorders is done in two phases:

Phase one is the diagnosis, where the orthopedic doctor diagnoses the existence of a spinal disorder and evaluates the severity of the disease. The diagnosis can be done through the following ways: a physical examination, tests like the Adam's forward bend test, an X-ray spinal radiograph which can be either posteroanterior, a.k.a PA, (frontal) view or lateral, (sagittal) view, Computed Tomography scan (CT-scan), and Magnetic Resonance Imaging (MRI).

Phase two is the treatment, where the orthopedic doctor manages the spinal disorder. The treatment phase can include different methods and techniques to each case according to factors such as the determination of the exact type of the spine disorder, the severity of the disease, the degree of deformity or dislocation, the age of the patient, their gender, the duration and progress of the disease, and etc. The treatment methods can consist of observation and monitoring, physical therapy, bracing, casting and surgery.

Many times, the assessment of spinal disorders and diseases is done by orthopedic doctors manually using their naked eyes. In particular, they may need to perform tasks such as calculating angles, estimating the curvature of the spine, evaluating curve types, calculating the distance between consecutive vertebrae or associated shapes, and etc manually, without the assistance of any computer-assisted tool or software that automates the process. These are tedious tasks that depend on doctor's observation and require a lot of experience. Junior doctors or clinicians with less experience in field of orthopedics may be more easily inclined to make mistakes.

For instance, in the diagnosis of scoliosis, an inexperienced doctor may identify incorrectly the upper or lower end vertebra. Hence, an incorrect identification can contribute to an underestimation on the occurrence of the angle of curvature, resulting in a delayed or inappropriate treatment to patients, which can lead to a further curve progression before reaching the skeletal maturity.

Orthopedic doctors with expertise in the clinical diagnosis of Scoliosis assessment need to determine the upper and lower ends of the problematic vertebrae by naked eye. Also, they manually calculate the Cobb angle, the curvature of the spine and other. These tasks are tedious and extremely time consuming for doctors. Hence, there is need for the development of a system application that assist them in this task.

In the recent years, researchers and clinicians start to take advantage of the benefits from computer-assisted innovations in the medical fields. For instance, machine learning can be applied to data analysis in medical images so as to better identify, classify and quantify patterns for image registration, anatomical structures detection, and bone/tissue segmentation. A number of exemplary patent publications that use the computer vision system or method for the assessment of the spine are presented below.

U.S. Patent Publication No. 20210275229, which is titled “SCOLIOSIS CORRECTION SYSTEMS, METHODS, AND INSTRUMENTS”, filed on Apr. 28, 2021 and published on Sep. 9, 2021, is a system that specializes on the Scoliosis.

U.S. Patent Publication No. 20170119316, which is titled “ORTHOPEDIC MEASUREMENT AND TRACKING SYSTEM”, filed on Oct. 26, 2016 and published on May 4, 2017, performs edge detection algorithms on fluoroscope images.

U.S. Patent Publication No. 20200107883, which is titled “A SPINE MEASUREMENT SYSTEM AND METHOD THEREFOR”, filed on Dec. 11, 2019 and published on Apr. 9, 2020, is a computer vision method for processing fluoroscope images of spine in which each vertebra has a corresponding pedicle screw and calculates metrics in order to assist doctors in their assessment of the spine.

U.S. Patent Publication No. 20170340268, which is titled “X-RAY IMAGING FOR ENABLING ASSESSMENT OF SCOLIOSIS”, filed on Feb. 13, 2017 and published on Nov. 30, 2017, uses computer vision method for the assessment of the Scoliosis.

U.S. Patent Publication No. 20040215074, which is titled “Imaging and scoring method for cervical spinal impairment using magnetic resonance imaging”, filed on Apr. 24, 2003 and published on Oct. 28, 2004, performs assessment of the spine using MRI scan images.

U.S. Patent Publication No. 20210145519, which is titled “SYSTEMS AND METHODS FOR MEDICAL IMAGE ANALYSIS”, filed on Dec. 22, 2020 and published on May 20, 2021, uses computer vision methods for the assessment of the spine.

U.S. Patent Publication No. 20210290315, which is titled “SYSTEM METHOD AND COMPUTER PROGRAM PRODUCT, FOR COMPUTER AIDED SURGERY”, filed on Jan. 8, 2021 and published on Sep. 23, 2021, is one of the many publications that are related to spine surgeries the system.

### SUMMARY OF THE DISCLOSURE

It is therefore an object of the present disclosure to provide a system and method in computer application that assists the orthopedic doctors in the clinical diagnosis and assessment of various spine conditions, disorders and diseases, including Scoliosis, Scheuermann's Kyphosis and Compression Fracture, Spondylolisthesis and Degenerative Disk diseases.

The system is able to process any kind of frontal and sagittal images of the human spine. In particular, these pictures may be taken by any means, such as radiation, magnetic fields or waves. For instance, they can be X-rays, i.e. radiation radiographs; they can be MRIs, i.e. magnetic fields and radio waves; they can be fluoroscopic, i.e. dynamic images. The system detects and localizes each and every vertebra of the human spine, and extracts straight lines for each edge of each and every vertebra. In addition, the system is able to detect, on the input images, the four edges of each and every vertebra (i.e. upper, lower, right and left), and calculate and extract the four corresponding straight lines, one for each edge.

The system aims at assisting orthopedic doctors in the diagnosis of numerous spinal disorders and conditions and diseases where orthopedics need to examine tasks such as the alignment of the vertebrae, the distance between consecutive vertebrae, vertebrae deformities, any type of curvatures in the human spine, and etc.

For example, one of the spinal disorders where the system can provide assistance to the orthopedic doctors is scoliosis, where orthopedic doctors use a posteroanterior, a.k.a. PA (frontal) X-ray radiograph for diagnosing different types of scoliosis, such as Thoratic, Lumbar, Thoraco-Lumbar and any combination thereof. In all these cases, doctors have to calculate the curvature of the spine in different parts of the spine. They first need to detect the upper and lower edges of specific vertebrae and calculate the Cobb angle on the intersection of the two edges. The system, by extracting straight lines where the upper and lower edges of each and every vertebra, can assist doctors in saving valuable time.

Other examples of the spinal deformities are Compression Fracture and the Scheuermann's Kyphosis. In these instances, doctors use lateral (sagittal) X-ray radiographs of the human spine, calculate the curvature of the spine, and detect the vertebrae that have a wedge shape instead of a rectangle. The system, by extracting the upper and lower edges of each vertebra, can detect any deformed vertebrae that suffer from the illustrated diseases.

Yet another example of the spinal disease is the Spondylolisthesis. In this condition, doctors also need a lateral (sagittal) X-ray radiograph of the human spine and detect any vertebrae that slip forward. The system is able to assist doctors in this diagnosis by detecting the corresponding lines for the left and right edges for each and every vertebra and by determining where the dislocations occur.

Other exemplary spinal diseases include Thinning and Degenerative Disk Diseases. For the diagnosis of these diseases the doctors need a sagittal X-ray radiograph of the human spine. The system is able to extract straight lines that correspond to the upper and lower edges of each and every vertebra and provide with information about the distances of consecutive vertebrae.

In the above-mentioned spinal conditions, orthopedic doctors with professional experience in assessing spine conditions and diseases need to detect the problematic vertebrae of the spine by naked eye, and perform calculations manually, without the assistance of any computer-assisted tool or software that automates the process, such as estimating angles, calculating the curvature of the spine, measuring the distance between consecutive vertebrae, estimating the shape of a vertebra, and etc. These are tedious and time consuming tasks that clinical researchers and orthopedic doctors with professional experience in assessment of spine conditions and diseases need to perform in order to diagnose the severity of the condition of the spine of each patient. Another difficulty is that it is not always easy and clear to distinct details of a vertebra such as their edges on an X-ray by naked eye. In some cases more than one doctors are needed to validate and confirm the result. Therefore, the system aims at assisting doctors in these diagnostic tasks, by performing these tasks for them.

The system receives as an input any type of frontal and sagittal images of the human spine. These pictures may be taken by any means, such as radiation, magnetic fields or waves. For instance, the input images can be X-rays, i.e. radiation radiographs; MRIs, i.e. magnetic fields and radio waves; fluoroscopic, i.e. dynamic images. Specifically, the system has two phases: phase one performs the task of object detection; and phase two performs the task of edge detection and extracts straight lines that correspond to each edge of each and every vertebra. In a next step, according to the characteristics of each disorder, the system generates results by estimating either the distance between the detected edges, their angles, whether the shape of a vertebra is rectangle or not, or any other metric that is needed in order to assist the orthopedic doctors in diagnosing the condition of the spine.

In particular, phase one performs object detection on frontal or sagittal pictures of the human spine by detecting and localizing each and every vertebra of the human spine on the input images. Every detected object is enclosed into one rotated rectangle bounding box that is determined on the image by its coordinates and its rotation angle.

In addition, phase two performs the task of edge detection on each detected vertebra of phase one. In particular, the input is each and every rectangle of the previous phase. This phase consists of multiple steps and algorithms. After the four edges of each vertebra (i.e. upper, lower, left, and right) are detected and located, an output of four corresponding straight lines, one for each edge, is generated.

At the end, these corresponding straight lines are used for further calculations each time according to the spinal condition and disease that the doctor needs to diagnose. For instance, in the case of scoliosis assessment, the system generates a summary clinical report wherein curve severity is defined by the severity of curvature based on the Cobb angle, curve type is defined by where the curve is located in the mid (thoracic) spine, lower (lumbar) spine or between thoracic and lumbar (thoracolumbar) spinal sections in accordance with Scoliosis Research Society guideline, and the number of curves is defined by how many curves occurring in each human's spine, and wherein all relevant clinical data includes age, Risser sign, age at menarche, sex gender, and other factors that relate to patients diagnosed with Adolescent Idiopathic Scoliosis. In cases of other diseases, similar reports are generated.

The system and method make use of the edge computing architecture. In general, the edge computing consists of two parts: a supercomputer where training of the models is done and an edge-device machine where predictions of the model are done. In particular, in the first phase of the system, the object detection model is already trained on the supercomputer using the labeled frontal and sagittal dataset of images of the human spine. These images may be taken by any means, such as radiation, magnetic fields or waves. They can be X-rays, i.e. radiation radiographs; MRIs, i.e. magnetic fields and radio waves; fluoroscopic images, i.e. dynamic images. When training is finished, the model weights and checkpoints are exported. Afterwards, these weights and model checkpoints are loaded in the edge-device machine. In addition, the edge-device machine has pre-installed the algorithms that are needed for performing edge detection on phase two.

Everything that a doctor needs for the assessment of the condition of the spine is pre-installed in the edge-device machine. Hence, the doctor will give as an input to the edge-device machine an image of the spine of a patient and will receive as output a detailed clinical report that is specialized on the characteristics of each spinal condition and disease.

In short, the system aims at assisting orthopedic doctors in the clinical assessment of orthopedic spine condition of a patient, which can include Scoliosis as well as other spine diseases and disorders. The system processes inputted images of the human spine of the patient, and uses the edge computing architecture and deep learning models for the detection of vertebrae in the human spine. The images can be either frontal or sagittal. These pictures may be taken by any means, such as radiation, magnetic fields, waves. For instance, they can be X-rays, i.e. radiation radiographs; MRIs, i.e. magnetic fields and radio waves; fluoroscopic, i.e. dynamic images. The output of the system is straight lines that correspond to the edges of each and every vertebra of the human spine. The system uses two phases to assist doctors: The first phase contains object detection, deep learning model for detection and localization of each and every vertebra of the human spine. Specifically, any kind of frontal and sagittal pictures of the human spine, which can be radiation radiographs (X-rays), magnetic resonance imaging (MRI) and fluoroscopic (dynamic) images, can be taken by any means, such as radiation, magnetic fields or waves, and processed. The second phase contains a workflow of algorithms for edge detection for each vertebra and extraction of straight lines that correspond to each edge. Specifically, the system in the second phase allows for diagnosis, observation and monitoring where progress of the treatment based on the assessment of the condition of the spine is constantly evaluated. As a result, a clinical report for spinal assessment that is specialized in each condition of the spine is generated.

### BRIEF DESCRIPTION OF THE DRAWINGS

Additional features and advantage of the present disclosure will be made apparent from the following detailed description of one or more exemplary embodiments with reference to the accompanying figures, which are given for illustrative purpose only, and thus are not limitative of the present disclosure, wherein:

FIG. 1 is a flow chart showing the system conducting a spine assessment;

FIG. 2 is a posteroanterior (PA) X-ray radiograph image with its vertebrae detected from phase one of the system;

FIG. 3 is another flow chart showing phase two of the system;

FIG. 4 shows exemplary spine conditions, disorders and diseases that can be assessed by the system;

FIG. 5 shows a specific spine disorder relating to Adolescent Idiopathic Scoliosis; and

FIG. 6 shows a calculation of the Cobb angle in two spine locations as depicted in FIG. 5.

### DETAILED DESCRIPTION OF THE EXEMPLARY EMBODIMENTS

One or more exemplary embodiments according to the present disclosure on the system and method that aim to assist orthopedic doctors and clinicians in the assessment of the condition of a human spine will be described below with references to the accompanying figures.

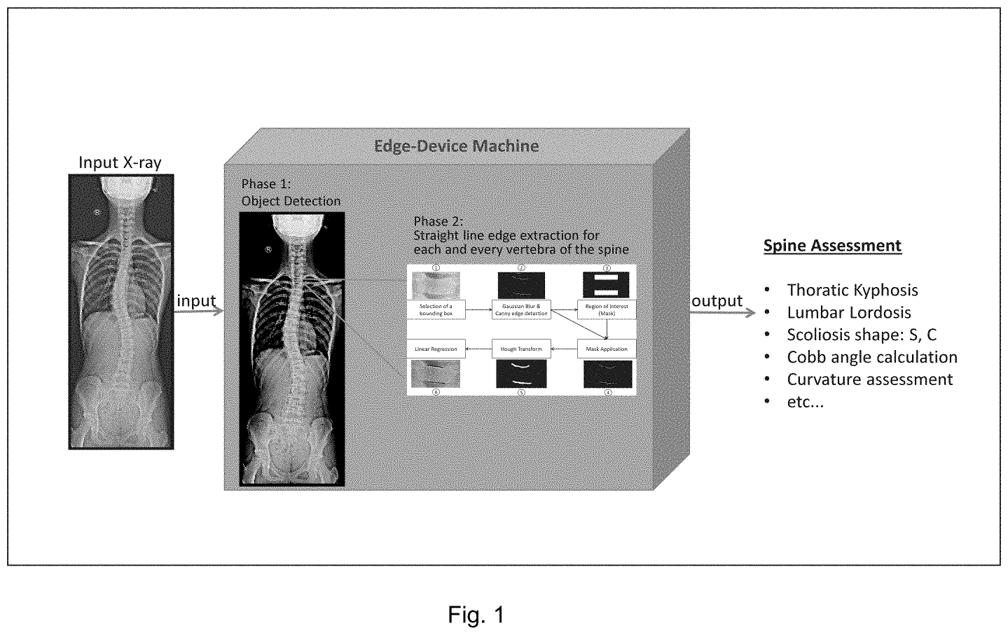

FIG. 1 is a flow chart showing the system conducting a spine (scoliosis) assessment. The edge-device machine first receives as input a posteroanterior, PA (frontal) patient's X-ray radiograph. In other words, the input for the edge-device machine is an X-ray radiograph of the human spine. Next, the system uses the architecture of the edge computing framework. In FIG. 1, the depicted edge-device machine processing is performed using pre-installed and pre-loaded models and weights for object detection, i.e. vertebra detection in phase one, and the algorithms for edge detection and straight line extraction in phase two.

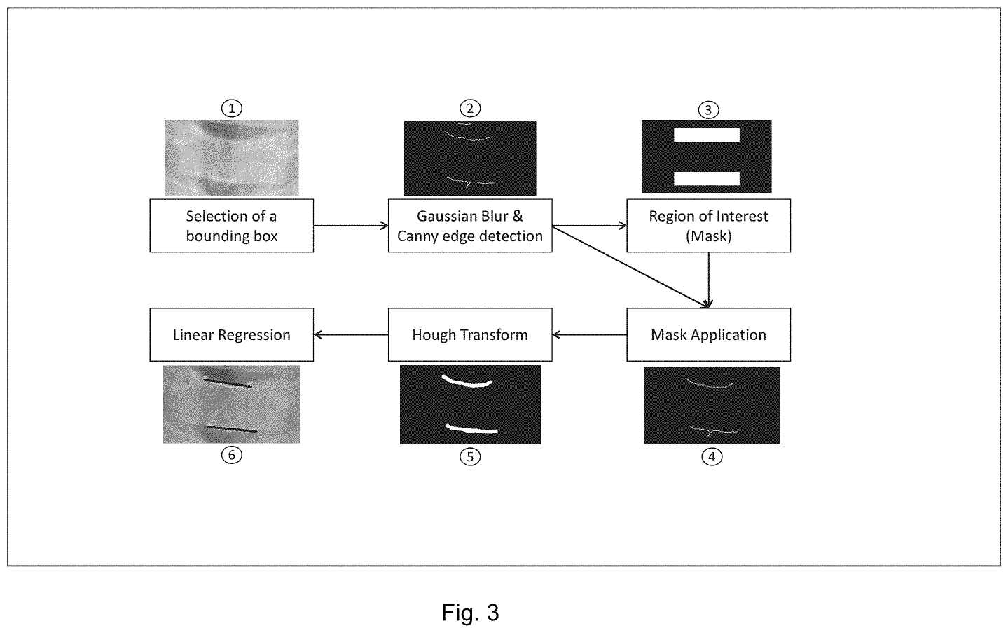

More specifically, in the first phase or phase one, object detection is performed where each and every vertebra of the human spine is detected and located. An object detection deep learning algorithm, which detects and locates each and every vertebra of the human spine in the X-ray radiograph of the patient, is also initiated. Each detected vertebra is enclosed into a rotated bounding box, which is determined in the image by its coordinates and a rotation angle. In the second phase, edge detection is performed in six steps, which are further depicted in FIG. 3. The output of phase two is straight lines which correspond to the edges of each vertebra. Then, a specialized clinical report, which in the spine assessment is related to scoliosis diagnosis, is generated according to the spinal disease.

In the second phase or phase two, the location of the upper and lower edges and how much tilting they have for each and every vertebra by extracting straight lines with their slopes are specified for each edge.

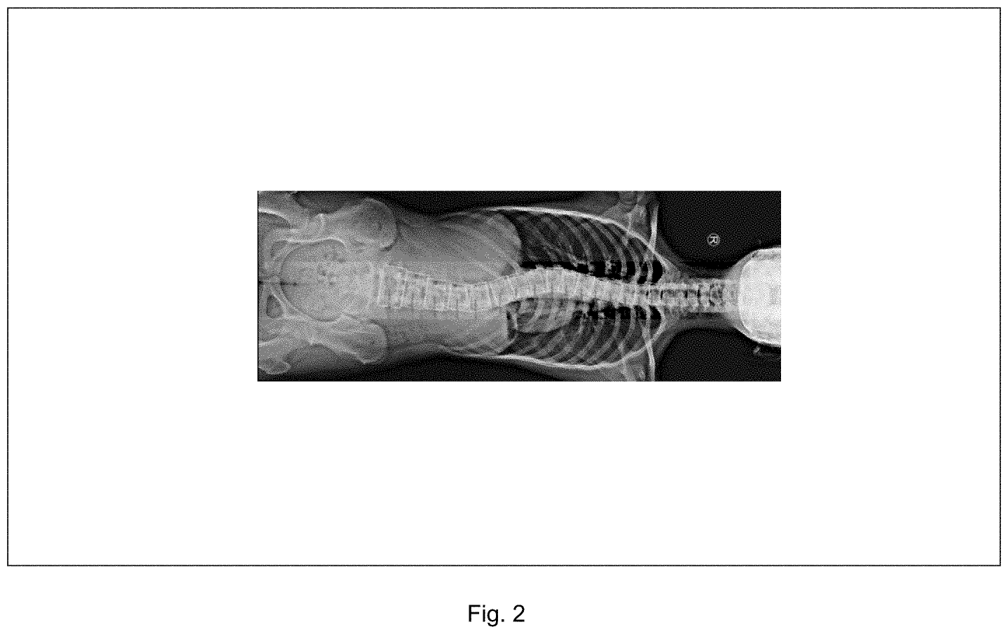

FIG. 2 shows a result of the phase one detection. Specifically, the depicted result is generated from the object detection deep learning model that detects and localizes each and every vertebra of the human spine. Each detected vertebra is enclosed within a rotated bounded box and has a probability assigned to it. Each rotated bounding box is determined by its coordinates on the image and a rotation angle.

FIG. 3 illustrates a flow chart for the second phase of the system in a further detail. Among the 6 steps shown, step 1 is the section of picking a bounding box; step 2 is the application of Gaussian blurring method and Canny edge detection algorithm; step 3 is the determination of a region of interest where either the horizontal edges are kept, or the vertical, or all of them; in step 4, the mask of step 3 is applied to the result of step 2; in Step 5, the Hough transform algorithm is applied; and in step 6, the Linear Regression algorithm is applied for each of the detected edges in order to extract straight lines that correspond to each detected edge.

The particular order of transformations in the second phase is discussed below. The first step involves a selection of a bounding box from the result of the object detection algorithm in the first phase of the system. The second step relates to Gaussian Blur and Canny Edge Detection. In particular, the Canny edge detector is a popular and widely used edge detection operator that uses a multi-stage algorithm to detect a wide range of edges in images.

In the third step, a Region of Interest (ROI), a.k.a. a mask, is defined. For this particular spine disorder (i.e. the scoliosis), one would be interested in the horizontal edges of each vertebra only. Therefore, the vertical edges are ignored. Thus, in order to capture the upper and lower edges of each vertebra only, using two white rectangles, the areas in the image are determined where the upper and the lower edges are estimated. That way, after discarding the parts of the image that hide the mask, the rest parts of the image can be ascertained.

In the fourth step, the mask of the third step is applied to the result of the second step. In other words, only the Region of Interest from the image of step 2 is kept. The result of this step is an image that contains only the area where the two horizontal edges of the vertebra fall.

In the fifth step, the Hough Transform algorithm is applied. This algorithm extracts many small straight line segments out of each edge. The purpose of this operation is to approximate the shape of each edge with multiple small straight line segments and to extract the coordinates of the data points that fall on these line segments. The input of this algorithm is the part of the image that contains one of the edges. The output will be data-points that define segments of lines that approximate the input edge. This algorithm is executed twice: one for the upper edge and another for the lower edge. As a result, the final output of this step will be two sets of data-points, one for the upper edge and another for the lower edge, each of which determine line segments that approximate each edge. In this step, each edge is approximated by many small line segments that are defined each by a starting data point and ending data point.

In the sixth step, the Linear Regression algorithm is applied in order to receive one final straight line for each edge. In the Linear Regression algorithm, a set of data-points are received as input that determine line segments that approximate an edge (that were generated on the fifth step), and the output is one straight line that passes through the middle of all the data points. In particular, the Linear Regression algorithm is applied twice, i.e., once for the upper set of data points (upper edge), and another time for the lower set of data points (lower edge).

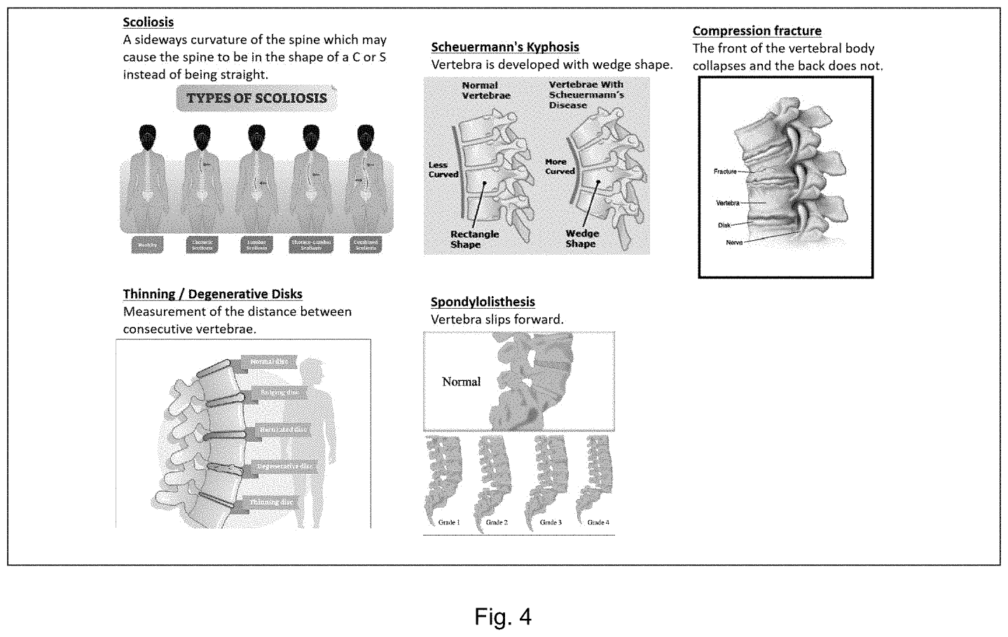

FIG. 4 shows spine conditions, disorders and diseases where the system can be utilized. In particular, the spine conditions, disorder and diseases that the system can be used include: (1) Scoliosis (a sideways curvature of the spine which may cause the spine to be in the shape of a C or S instead of being straight); (2) Scheuermann's Kyphosis where vertebra is developed with a wedge shape; (3) Compression Fracture where the front of the vertebral body collapses and the back does not; (4) Thinning or Denerative Disks where the disc starts to shrink, lose its shape, lose its flexibility, wear out or get very thin as measured by the distance between consecutive vertebrae; and (5) Spondylolisthesis where vertebra slips forwards.

In the cases of Scheuermann's Kyphosis and Compression Fracture as shown in FIG. 4, an X-ray radiograph of the lateral (sagittal) view of the human spine is inputted, with the rest performed similar to the case of the Scoliosis, except that in phase one, an object detection, i.e. vertebra detection on the sagittal view of the X-ray radiograph, is applied, and that in phase two, the upper and lower edges for each and every vertebra are applied to yield a mask with two horizontal area rectangles, i.e., one for the upper edge and another for the lower edge. At the end, the system determines the vertebrae with the most wedged shape and calculates the curvature of the spine and other medical information, in order to assist orthopedics in assessing the severity of the condition.

Additionally, in the case of Spondylolisthesis, an X-ray radiograph of the lateral (sagittal) view of the human spine is needed as an input to the system. Hence, in phase one, object detection, i.e. vertebra detection on a sagittal X-ray, is performed. However, in this case, the vertical edges of each and every vertebra of the human spine are needed. As such, step 3 in phase two of the system needs to be modified in that the Region of Interest need to include the vertical edges for each vertebra as to allow the mask to keep the vertical edges instead of the horizontal edges.

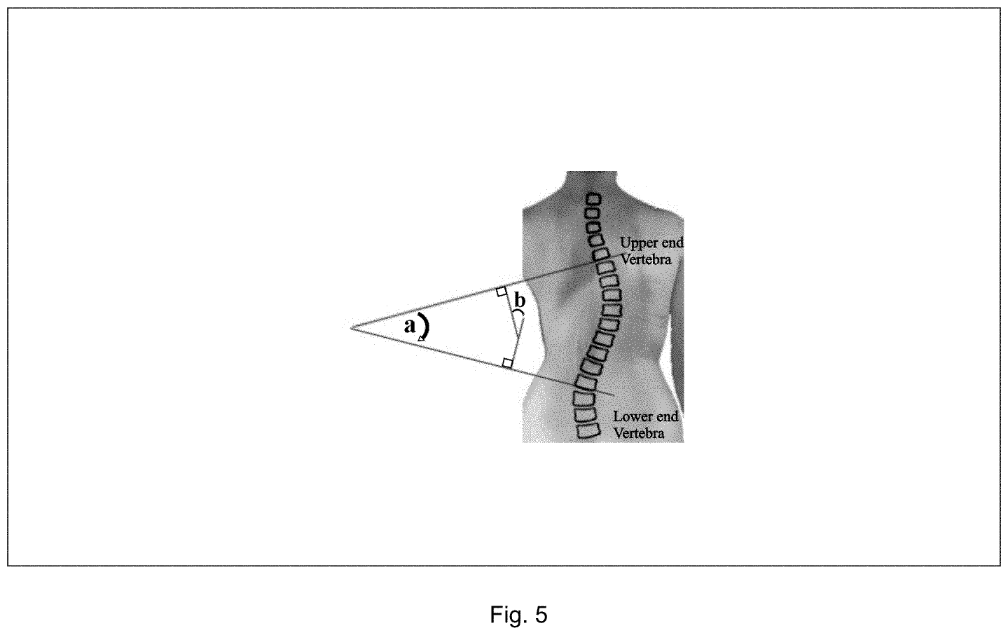

FIG. 5 shows a specific spine disorder the system can be applied. A human back with Adolescent Idiopathic Scoliosis (AIS) with the vertebrae drawn is shown, as well as two ways of estimating the Cobb angle, which yield the same result. For instance, one way is to calculate the Cobb angle directly, and the other way is to calculate the Cobb angle geometrically.

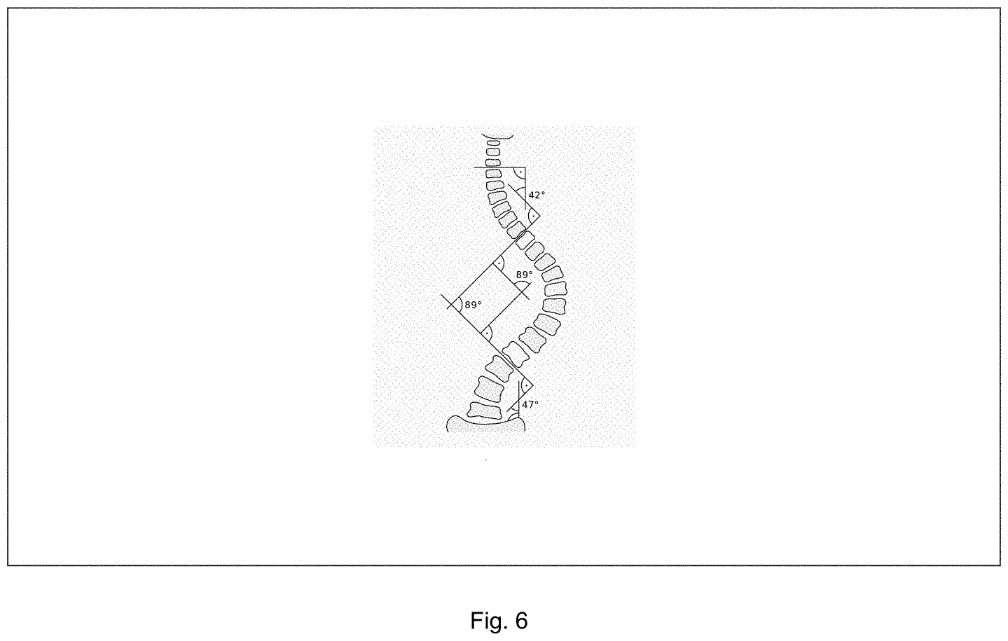

FIG. 6 is another figure similar to FIG. 5 that shows again the calculation of the Cobb angle of a spine in two places for the case of Adolescent Idiopathic Scoliosis (AIS). Specifically, Scoliosis can be diagnosed using X-ray radiographs that can include a standing x-ray of the entire spine looking from the front and back ends.

In the exemplary embodiment as shown in FIGS. 5 and 6, the Cobb angle is measured at the angle between the two vertebrae that are most tilted relative to the horizontal at upper and lower levels of each curve. More specifically, having a Cobb angle of more than or equal to 10 degrees is regarded as a minimum angulation to define Scoliosis; a Cobb angle of between 10 to 25 degrees is regarded as a mild curvature; a Cobb angle of between 25 to 40 degrees is regarded as a moderate curvature; and a Cobb angle more than 40 degrees is regarded as a severe curvature. The inclination of a line joining the mid-points of two sides of the vertebra is parallel to the superior and inferior end plates, and such defined as the inclination angle. The greatest inclination angles at the upper and lower parts of curvature are classified as the upper and lower end vertebrae, respectively.

The system detects the upper and lower edges of each and every vertebra of the human spine and extracts two straight lines. One straight line corresponds to the upper edge, and another straight line to the lower edge. As such, the Cobb angle that is described hereinabove can be calculated by using these extracted straight lines. Such way is fast and accurate, and does not suffer from human error and saves doctors' valuable time.

The system makes use of the architecture of edge computing system. The algorithms and models are pre-installed in the edge-device machine. The edge device machine is installed in the doctor's exam room or any other appropriate facility of a hospital or a clinic. The whole processing is performed on the edge-device and the results are shown on a monitor screen that is connected to it. No any further communication of the edge device with any outer processing device is required.

Although the present disclosure has been described with reference to specific embodiments, this description is not meant to be construed in a limiting sense. It should be understood that the scope of the present disclosure is not limited to the above-mentioned embodiments, but is limited by the accompanying claims. It is, therefore, contemplated that the appended claims will cover all modifications that fall within the true scope of the present disclosure. Without departing from the object and spirit of the present disclosure, various modifications to the embodiments are possible, but they remain within the scope of the present disclosure, will be apparent to persons skilled in the art.

What is claimed is:

1. A computer vision system using an edge computing architecture to process frontal and sagittal images of a human spine in order to detect a plurality of edges of each and every vertebra of the human spine, and extract straight lines that correspond to the detected edges, comprising:
an edge device pre-installed with a method of using first and second phases to perform a task of vertebrae and edge detection on the input images, and extract the corresponding straight lines for each of the four edges from each and every vertebra of the human spine,
wherein the edge device includes training of weights and checkpoints needed for processing the frontal and lateral images of the human spine.

2. The computer vision system of claim 1, wherein the frontal and sagittal images of the human spine, which comprise radiation radiographs, magnetic resonance imaging and fluoroscopic or dynamic images, are obtained through radiation and magnetic fields or waves.

3. The computer vision system of claim 2, wherein the first phase includes object detection and deep learning models that are trained on the frontal and sagittal images of the human spine for detection and localization of each and every vertebra of the human spine, wherein the second phase is an edge detection process that locates the four edges of each and every vertebra of the human spine, and extracts the straight lines for each of the four edges of the vertebra, in a way that each straight line corresponds to one edge of a vertebra, and wherein the straight lines extracted for each vertebrae includes a first line for an upper edge, a second line for a lower edge, a third line for a left edge, and a fourth line for a right edge.

4. The computer vision system of claim 3, wherein any type of frontal and sagittal image of the human spine is used as an input and the location of each and every vertebra is determined and outputted contained within rotated bounding boxes, which enclose one vertebra each and are extracted in the form of pixel coordinates of the input image and a rotation angle.

5. The computer vision system of claim 1, wherein weights of deep learning and object detection models for all different kinds of frontal and sagittal pictures of the human spine, i.e. images taken by radiation, or magnetic fields or waves, along with model checkpoints, labels and tuned parameters, that are used to train the system, and wherein the system is trained on a supercomputer, and weights and checkpoints of the supercomputer have been exported and installed in the edge device to enable the edge device to generate predictions and final results based on the training.

6. The computer vision system of claim 5, wherein the second phase is the edge detection process that uses the rotated bounding boxes from the object detection model in phase one as the input, then outputs straight lines that correspond to the edges of each vertebra, and extracts the four edges of each and every vertebra of the human spine, with the edges extracted in the form of straight lines having one straight line for each edge and a total four straight lines extracted that correspond respectively to the upper edge, lower edge, left edge, and right edge.

7. The computer vision system of claim 6, wherein the edge detection process includes the steps of:
inputting all of the rotated bounding boxes detected in the first phase of the system, and processing each and every rotated bounding box;
applying Gaussian Blur algorithm followed by Canny edge detection algorithm to generate a result;
defining a Region of Interest as a mask, and determining all edges, including horizontal and vertical edges, of each vertebra;
applying the mask to the result;
applying Hough transform; and
applying Linear Regression algorithm to extract at least one corresponding straight line for each of the four vertebra edges.

8. The computer vision system of claim 7, wherein models and algorithms are pre-installed in the edge device to perform processing independently, and to provide with a final clinical report that is specialized on a spine disease on a monitor screen connected to the edge device for the orthopedic doctor to evaluate and assess the condition of the spine without requiring communication with one or more external processing devices.
